(19) United States
(12) Patent Application Publication
(10) Pub. No.: US 2005/0015766 A1
(43) Pub. Date: Jan. 20, 2005

(54) Time deadline based operating system

(76) Inventors: Brian Nash, Swindon (GB); Timothy Curtis, Tetbury (GB)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/612,826

(22) Filed: Jul. 1, 2003

(51) Int. Cl. G06F 9/46

(52) U.S. Cl. 718/102

(57) ABSTRACT

According to one exemplary embodiment of the present invention, a computer system is provided. The computer system comprises a timer, and a table storing a start time for each process of a preselected set of processes. The computer system includes an operating system that causes execution of each process based on a time out of the timer, each process starting execution according to the corresponding start time stored in the table.

### BACKGROUND INFORMATION

A computing environment comprising, for example, a CPU, memory and Input/Output (I/O) devices, typically includes an operating system to provide a mechanism for controlling the allocation of the resources of the environment. Traditional multitasking operating systems (e.g., UNIX, Windows) have been implemented in computing environments to provide a way to allocate the resources of the computing environment among various user programs or applications that may be running simultaneously in the computing environment. The operating system itself comprises a number of functions (executable code) and data structures that may be used to implement the resource allocation services of the operating system.

Operating systems have been designed to function in an embedded system. Such operating systems are usually designed to function without human intervention and are simple enough to be written as a single program. Typically, the operating system for the embedded system is designed to provide a response within a set period of time.

“Real-time operating systems,” have been developed to provide a more controlled environment for the execution of processes, including tasks and Interrupt Service Routines, associated with application programs in an embedded system. Real-time operating systems are designed to be “deterministic” in their behavior—i.e., the execution of tasks by the computing environment, in response to events, can be expected to occur within a known time of the occurrence of the event, without fail. Determinism is particularly necessary in “mission-critical” and “safety-critical” applications, where the outcome of event responses is essential to proper system function. Real-time operating systems are therefore implemented to execute as efficiently as possible with a minimum of overhead.

In known real-time operating systems, the deterministic functionality is implemented by a prioritization scheme. The execution of tasks by the computing environment is performed as a function of priority levels assigned to the tasks by developers of the environment. For example, a task that must be executed at certain times for mission critical or safety critical reasons would be assigned a high priority level. Such a high priority level task would be able to preempt another currently executing lower priority level task whenever it had to be executed, as, e.g., upon the occurrence of a certain event. In this manner, responses to events that are mission critical can be expected to occur within an acceptable real time constraint.

Interrupt Service Routines (ISR's) can also be assigned priority levels. An interrupt is generally defined as a break in the usual flow of an executing task, to process an external request. Detection of a parameter being monitored by the computing environment can cause such a request. An ISR is the code executed to process the external request that causes the interrupt.

Priority based real-time operating systems have proven to be effective in obtaining adequate deterministic functionality. However, efforts continue to improve the real time responsiveness of operating systems.

### SUMMARY OF THE INVENTION

According to one exemplary embodiment of the present invention, a computer system is provided. The computer system comprises a timer, and a table storing a series of events for each process of a preselected set of processes. The events comprise a start time for each process. The computer system includes an operating system that causes execution of each process based on a time out of the timer, each process starting execution according to the corresponding start time stored in the table. The timer is arranged and configured to be set for a time out at each of a series of reload values, each reload value being equal to a number of time increments until a next event in the table.

According to another exemplary embodiment of the present invention, a method is provided. The method comprises the steps of providing a timer and a series of events for each process of a preselected set of processes, the events comprise a start time for each process and starting execution of each process based on a time out of the timer, each process starting execution according to the corresponding start time. The method comprises the further steps of providing a table, storing each event in the table, and operating the timer to be set for a time out at each of a series of reload values, each reload value being equal to a number of time increments until a next event in the table.

According to still another exemplary embodiment of the present invention, a method is provided for scheduling one or more processes. The method comprises the steps of starting a plurality of processes based on a time out of a timer, each process starting execution according to a start time specified in a time table. If one of the processes starts execution while another process is executing, preempting the process already executing, if one of the processes has been preempted and the process that preempted the process stops execution, resuming the process that has been preempted. Moreover, based on a time out of the timer, stopping execution of the processes regardless of whether the process has stopped execution normally, each process stopping execution according to a deadline specified in the time table. The timer is set for a time out at each of a series of reload values, each reload value being equal to a number of time increments until a next one of a start time and deadline in the time table.

According to another exemplary embodiment of the present invention, a method for scheduling one or more processes is provided. The method comprises the steps of providing a plurality of timers, starting a plurality of processes based on a time out of a first one of the timers, each process starting execution according to a start time specified in a time table, and based on a time out of a second one of the timers, stopping execution of the processes regardless of whether the process has stopped execution normally, each process stopping execution according to a deadline specified in the time table. According to the method of the present invention, the first one of the timers is set for a time out at each of a series of reload values, each reload value being equal to a number of time increments until a next start time in the time table, and the second one of the timers is set for a time out at each of a series of reload values, each reload value being equal to a number of time increments until a next deadline in the time table.

According to still another exemplary embodiment of the present invention, a computer system is provided. The computer system comprises a timer mechanism, and a table storing a series of events for each process of a preselected set of processes, the events comprising a start time for each process and a deadline for each process. Moreover, an operating system causes execution of each process based on a time out of the timer mechanism, each process starting execution according to the corresponding start time stored in the table and stopping execution according to the corresponding deadline stored in the table. The timer mechanism is arranged and configured to be set for a time out at each of a series of reload values, each reload value being equal to a number of time increments until a next event in the table. The timer mechanism comprises a first timer set for a time out at each of a series of reload values, each reload value being equal to a number of time increments until a next start time in the time table, and a second timer set for a time out at each of a series of reload values, each reload value being equal to a number of time increments until a next deadline in the time table.

### BRIEF DESCRIPTION OF THE DRAWINGS

FIG. 1 shows a block diagram of an exemplary computer system.

FIG. 2 shows first, second, and third time triggered tasks, according to the present invention.

FIGS. 3A and 3B show exemplary time tables used to control execution of time triggered tasks according to the present inventions.

FIG. 4 shows a conceptual diagram of a task.

FIG. 5 shows a conceptual diagram of a task placed in different states.

FIG. 6 shows an exemplary use of the states of FIG. 5 as applied to the present invention.

FIG. 7 shows how ISRs are handled according to the present invention.

FIG. 8 shows an exemplary method by which a time based operating system functions, according to the present invention.

FIG. 9 shows an exemplary embodiment of the present invention utilizing a periodic timer.

### DETAILED DESCRIPTION OF THE PREFERRED EMBODIMENTS

In a certain embodiment of the present invention, a time triggered approach is used to schedule the execution of tasks on an operating system. With a time triggered approach, a definite time when a task starts executing and a definite time when that task must stop executing, are each determined when the operating system is designed. For example, based on the operating system design, a task is started at a definite, specified start time. The execution of the task is then stopped at an expiration time (e.g., a deadline). However, it should be appreciated that the task may stop before the expiration time if it has completed execution.

Moreover, the times when an ISR can execute are also determined at design time. With regard to ISRS, an enable time is used to prevent an ISR from executing more than once until a known amount of time has elapsed. For example, the operating system can disable the ISR once it executes, and then enable the ISR once again when the enable time has elapsed (e.g., by use of a binary semaphore).

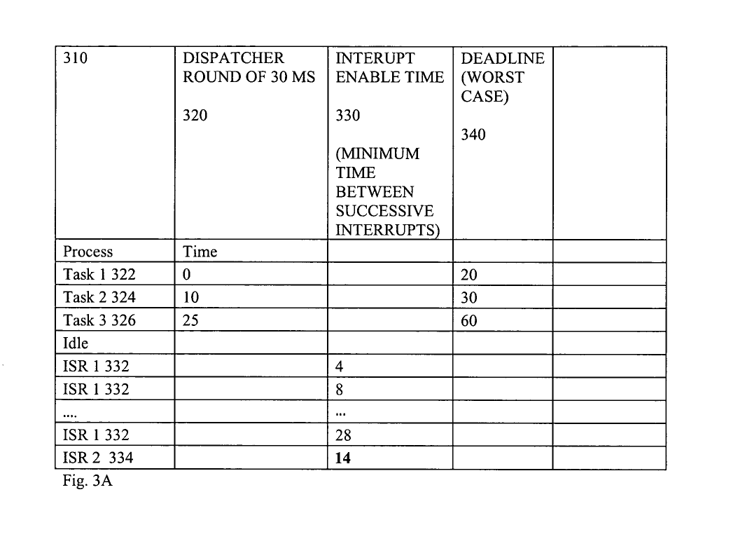

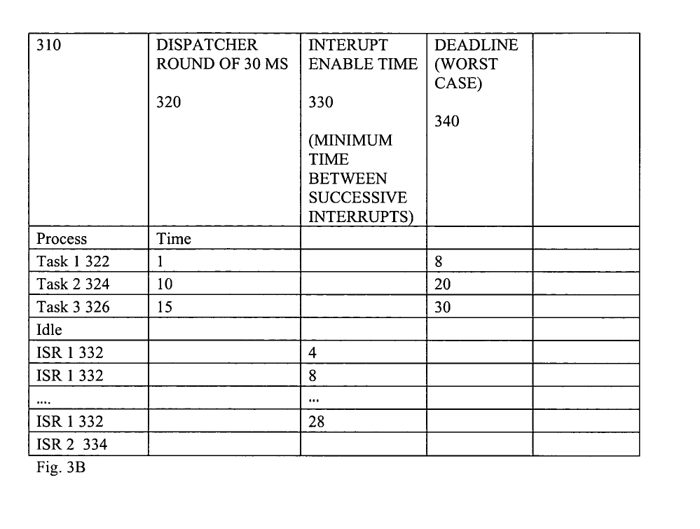

In an exemplary embodiment of the present invention, a time table, an example of which is shown in FIG. 3, is used to store information relating to the control the timing of the task(s) and/or ISR(s). A timer ISR can be implemented to act as a scheduler for the operating system. In this manner, the timer ISR can be activated by a time out of a timer in accordance with the information stored in the time table, and control task execution as a function of the time information, as will be described in more detail below. According to a feature of the present invention, in each instance of setting the timer for a time out, the timer is set to time out at a reload value. The reload value is set to equal the number of time increments of the timer until a next start time or deadline in the time table. Thus, according to an example of the present invention, a simple count down of the timer until a next time out is all that is necessary to cause starting and stopping a time triggered task.

This is more time efficient than the conventional use of a periodic timer, e.g. by internally counting and comparing ticks of the periodic timer. To schedule tasks and allocate processor time, an operating system uses a system timer (e.g., a periodic timer tick). Tasks can not be scheduled more accurately than the frequency of the system timer. The frequency of the system timer is not limited by the hardware, since an interrupt can usually be generated every clock cycle. Instead, the frequency limitation is in the operating system, which processes information on every timer tick. Preferably, in an embodiment according to the present invention, there are no limits on the clock tick rate that can be accommodated by the operating system, other than the available processor cycles that can be utilized by the system. Preferably, the tasks and ISRs are scheduled with a precision of 1 microsecond.

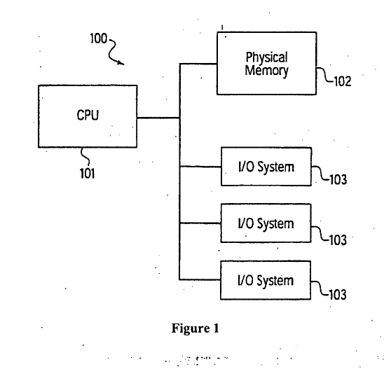

Referring now to the drawings, and initially to FIG. 1, there is illustrated in block diagram form, a computer system 100 comprising a CPU 101, which is coupled to a physical memory system 102 and a number of I/O systems 103. Connection of the CPU 101 to the physical memory system 102 and the number of I/O systems 103 may be according to any of the well known system architectures (e.g., PCI bus) and may include additional systems in order to achieve connectivity. I/O systems 103 may comprise any of the well known input or output systems used in electronic devices (e.g., key pad, display, pointing device, modem, network connection). Physical memory system 102 may include RAM or other memory storage systems, and read only memory and/or other non-volatile storage systems for storage of software (an operating system, other applications) to be executed in the computer system 100. Alternately, software may be stored externally of computer system 100 and accessed from one of the I/O systems 103 (e.g., via a network connection). CPU 101 may also include a memory management unit (MMU, not shown) for implementing virtual memory mapping, caching, privilege checking and other memory management functions, as is also well known.

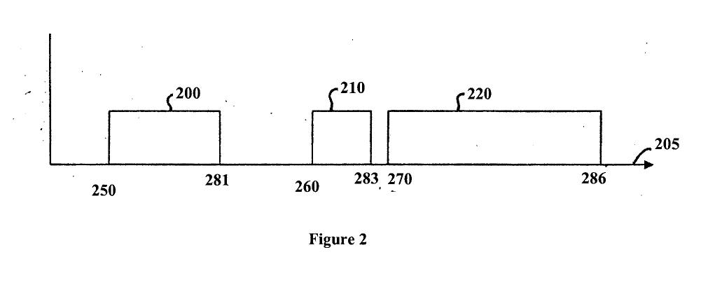

FIG. 2 shows a time line illustrating a simple example of first, second, and third time triggered tasks 200, 210, 220 to be executed by the computer system 100 of FIG. 1, according to an exemplary embodiment of the present invention. The x axis 205 represents the progression of time. At a first start time point 250, the first time triggered task 200 starts execution. At or before the first time point 250 a timer (e.g., a variable) is set to expire at a first expiration time or deadline 281 for the first time triggered task 200. At the first deadline 281, the first time triggered task 200 stops execution regardless of whether the first time triggered task 200 has completed execution or not. Also, in this example, when the first expiration time 281 occurs, the timer is set for a second start time point 260. When the timer expires at the second start time point 260, the second time triggered task 210 starts execution, and the timer is set to expire at a second expiration time or deadline 283 for the second time triggered task 210. When the second deadline 283 occurs, the second time triggered task 210 stops execution regardless of whether the second time triggered task 210 has completed execution or not. Also, when the second expiration time 283 occurs, the timer is set for a third start time point 270. When the timer expires, the third time triggered task 220 starts execution, and the timer is set to expire at a third expiration time or deadline 286 for the third time triggered task 220. When the third deadline 286 occurs, the third time triggered task 220 stops execution regardless of whether the third time triggered tasks 220 has completed execution or not.

The first, second, and third time points 250, 260, 270 are determined at design time and are stored in the time table. The first, second, and third expiration times or deadlines 281, 283, 286 are also determined at design time and are stored in the time table. In one example, the expiration times 281, 283, 286 could be scheduled at 10 ms, 20 ms, and 30 ms, respectively.

In certain embodiments according to the present invention, more than one timer can be used. For example, a separate timer could be used for each start time and each expiration time or deadline. Also, in a certain embodiment of the present invention, a timer can be set for the first point in time 250 before the first task 200 starts execution. Then, when the timer expires, the first task 200 begins execution.

FIG. 3A shows an exemplary time table 300. Preferably, the time table is created when the operating system is configured. The table includes a first column 310 that shows a list of processes that can include tasks and/or ISRs. In the present example, first, second, and third tasks 322, 324, 326 are shown. Also shown in the present example are first and second ISR's 332, 334. The time table shown in FIG. 3A allows for disablement and re-enablement of ISRs (explained below). A second column 320 determines at what time each of the first, second, and third tasks 322, 324, 326 start execution. If a particular task has not finished execution at a time when a subsequent task is scheduled to start, the particular task is placed in a preempted state (e.g., pushed to a stack) and the subsequent task begins execution. For example, the first, second, and third tasks 322, 324, 326 can be set to start execution at 0 ms, 10 ms, and 25 ms, respectively. A third column 330 determines at what time the first and second ISRs 332, 334 are re-enabled. For example, the first ISR 332 can be re-enabled at 4 ms, 8 ms, and 28 ms. A fourth column 340 determines a deadline for the first, second, and third tasks 322, 324, 326. The deadline is used to specify the maximum amount of time a task can execute before execution of the task is stopped. If the deadline is reached before the task has finished execution, the operating system or user can be informed by a message (e.g., an error message). Note that the deadlines can be set at times after a subsequent task is scheduled to start. This is because a task can start, be interrupted by a subsequent task, resume, and then finish execution before the deadline occurs. In the example of FIG. 3A, the first, second, and third tasks 322, 324, 326 have deadlines of 20 ms, 30 ms, and 60 ms, respectively. The deadlines, start execution times, and ISR re-enable times are used when setting the timer(s).

As described above, the tasks and ISRs can also be assigned priority levels. As discussed above in respect of known real-time operating systems, the priority levels specify which process (e.g., a task or ISR) can preempt another process. Preferably, in this example of the present invention, all the tasks are assigned the same priority level, so that one task can not synchronously preempt another task. However, the interrupts can have different priority levels. For example, the highest priority level interrupt could be the timer ISR. Thus, when the timer expires, the timer ISR can interrupt a currently executing task or ISR and perform an action (e.g., push the currently executing task to a stack, and start execution of a next scheduled task, according to the time table). Other interrupts could have different levels.

Table 1 shows priority levels assigned to the tasks 322, 324, 326 and ISRs 332, 334 shown in FIG. 3A. In Table 1 the interrupts, as well as the tasks have priority levels. Preferably, the tasks all have the same priority level. If an interrupt has a higher priority level than a task, the interrupt can interrupt (e.g., preempt) the task. Likewise, if an interrupt has a higher priority level than another interrupt, the interrupt with the higher priority level can interrupt the interrupt with the lower priority level. For example, when an interrupt with a higher priority level than a currently executing process (e.g., a task or interrupt with a lower level) occurs, the current procedure is preempted (e.g., placed on a stack.) The interrupt then executes. When the interrupt finishes, the preempted procedure is removed from the stack and resumed. In certain embodiments according to the present invention, except for the idle task, no priorities are used for tasks. In such an embodiment, all the tasks are equal with regard to the operating system, and no task may interrupt another task.

TABLE 1

| Process | Level |
|---|---|
| Timer ISR | 1 |
| ISR 1 | 2 |
| ISR 2 | 2 |
| TASKS | 3 |
| Idle | 4 |

In Table 1 note that the highest priority level is indicated by the numeral 1, and the lowest priority level is indicated by the numeral 4. The Timer ISR has the highest priority level, thus it always has priority over any other ISRs or tasks. Also note that the Idle task has the lowest priority level, thus, any of the other tasks or ISRs can preempt the Idle task.

In the example given in FIG. 3A, a first task 322 starts at time 0. If the first task 322 does not finish by 10 ms, then at 10 ms the timer ISR causes the first task 322 to be preempted by a second task 324. This is because the second task 324 has a start time set in the table 300 at 10 ms. The first task 322 would be placed in a preempted state (e.g., pushed to a stack). Likewise, if the second task 324 does not finish by the 25 ms start time selected for a third task 326, then at 25 ms the second task 324 is preempted by the third task 326. If the second task finishes before 20 ms (the deadline set for the first task 322), the first task 322 can resume execution (e.g., is popped from the stack). However, if the first task 322 does not finish execution by 20 ms (the selected deadline time for the first task 322), execution of the first task 322 is ended by the operating system (e.g., the task is terminated). Likewise, if the third task 326 finishes execution before the 30 ms deadline for the second task 324 (as set in the table 300), the second task 324 can resume execution (i.e., is popped from the stack). However, if the second task 324 does not finish by the 30 ms deadline, execution of the second task 324 is ended by the operating system (e.g., the task is terminated). Of course, in this example, if the third task 326 does not complete execution by the 60 ms deadline set for the third task 326 in the table 300, execution of the third task 326 is ended by the operating system.

If the first ISR 332 occurs while any of the tasks are executing, the tasks are interrupted by the ISR 332 and could be placed in the preempted state. This is because the first ISR 332 has a higher priority level (e.g., 2) than the tasks (e.g., 4). When the first ISR 332 finishes execution, the previously executing task is popped from the stack and resumes execution (e.g., placed back in the running state). Note that if the deadline 340 for the task has passed due to the execution time of the first ISR 332, execution of the task is ended by the operating system.

In certain embodiments of the present invention, after the ISR finishes execution, a check could be made to determine if the deadline for a particular task has passed before resuming execution of the task. In such an embodiment, execution of the task could be stopped before resuming the task (e.g., the task is directly placed into the terminated state). After the first ISR 332 has executed, a semaphore or similar programing construct is set to prevent the first ISR 332 from executing until the interrupt enable time (e.g., time interval) listed in the second column occurs. When the interrupt enable time occurs (e.g., the timer reaches the specified time interval) the programing construct can be reset. For example, if the first ISR 332 executes at 2 ms, the first ISR 332 is prevented from executing again until the timer reaches 4 ms.

FIG. 3B is a table similar to FIG. 3A, except that some of the timer events are changed. The first, second, and third tasks 322, 324, 326 start execution at 1 ms, 10 ms, and 15 ms, respectively. Moreover, the deadlines for the first, second, and third tasks 322, 324, 326 are 8 ms, 20 ms, and 30 ms, respectively.

In the example given in FIG. 3B, the first task 332 begins execution at 1 ms. If the first task 322 does not finish by the 8 ms deadline set in the table for the first task 322, then at 8 ms the execution of the first task 322 is stopped (i.e., placed in the terminated state). The second task 324 begins at 10 ms (e.g, placed in the running state). If, for example, the first ISR 332 occurs at 13 ms, then the second task 324 is preempted (e.g., placed in the preempted state). The first ISR 332 then executes. If the first ISR 332 finishes execution before 20 ms, the second task 324 is popped off of the stack and resumed (e.g., placed in the running state).

However, if first ISR 332 is still executing at 15 ms (the start time for the third task 326), the timer ISR (which has the highest priority) interrupts the first ISR 332 to place the third task 326 on the stack (e.g., in the preempted state), the first ISR 332 then resumes execution. When the first ISR 332 finishes, the third task 326 is placed in the running state (e.g., popped from the stack). If the third task 326 finishes before 20 ms, the second task 324 is placed in the running state.

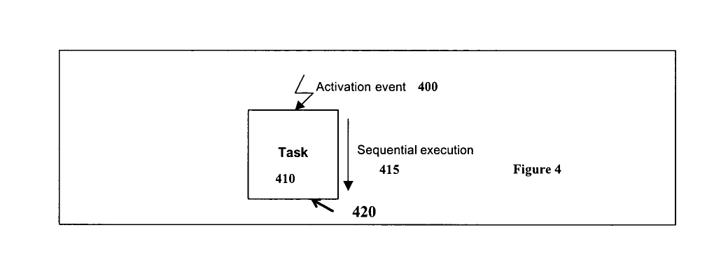

FIG. 4 shows a conceptual diagram of a task 410. An activation event 400 (e.g., expiration of the timer) starts the execution of the task 410. The task 410 then executes 415 until a stop event 420 (e.g., the task finishes execution or the timer expires) occurs.

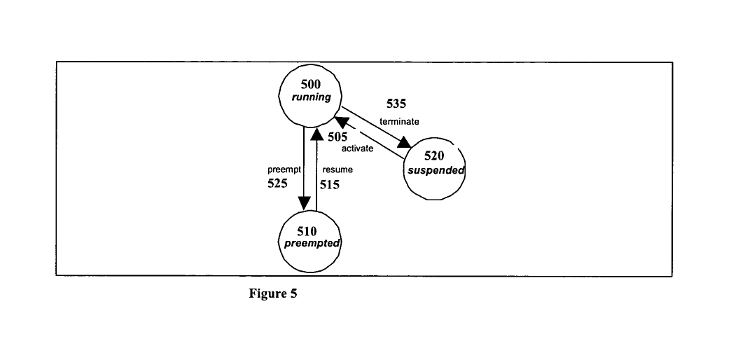

In certain embodiments according to the present invention, a task can be placed into different states. This is shown in FIG. 5. For example, a task can be in a running state 500, preempted state 510, or suspended state 520. In the running state 500, the processor is assigned to the task, so that the task can be executed. The running state 500 occurs, for example, when the task is executing. The suspended state 520 occurs when a task is passive, but can still be activated. In the suspended state 520, the task is not executing. For example, a task can enter the suspended state 520 when the deadline for the task has been reached. The suspended state 520 could also be the default state of any tasks that have not yet started execution. In the preempted state 510, the instructions of the task are not executing. The preempted state 510, for example, can be entered from the running state 500 by a currently executing task when another task changes from a suspended state 520 to the running state 500 upon the occurrence of the start time for the other task. Moreover, the preempted state 510 can occur when an ISR interrupts a currently executing task. In the preempted state 510, the data pertaining to the task could be stored by pushing the data onto a stack. When the task moves from the preempted state 510 to the running state 500, the data pertaining to the task could be popped from the stack.

State changes, which can be sent by, e.g., the scheduling process of a timer ISR, caused by expiration of the timer(s), can cause states to change from the running state 500, preempted state 510, or suspended state 520 to one of the other states. For example, an activate change 505 moves a task from the suspended state 520 to the running state 500. A resume 515 change moves a task from the preempted state 510 to the running state 500. Preferably, the last task to enter the preempted state 510 is the task that is moved to the running state 500. A preempt change 525 moves the task in the running state 500 to a preempted state 510. The preempt change could occur, for example, if another task start time occurs or an ISR preempts the current process. A terminate change 535 moves a task from the running state 500 to the suspended state 520.

In certain embodiments according to the present invention, when the timer expires, a scheduler, such as a timer ISR, could move the tasks from one state to another. For example, an activate change could be issued when a task is scheduled to start. A resume change could be issued when a task that has been preempted by the scheduler or by an ISR with a higher priority level, is moved back to the running state. A preempt change could be issued when the scheduler starts execution of a new task or when an ISR of a higher priority is activated. A terminate change could be issued when a task has completed execution. In certain embodiments according to the present invention, the task could issue the change instead of the scheduler. The scheduler can then place the task in the appropriate state. For example, on completion a task could issue a terminate command to the scheduler. Also, in certain embodiments of the present invention, the task could place itself in a particular state. For example, the timer could be implemented as a semaphore for each task. When the semaphore associate with the task reaches a deadline time, the task could terminate itself. In certain embodiments according to the present invention, a semaphore associated with each task could issue commands to change states. For example, the semaphore could place a task in a state and issue a message to the scheduler.

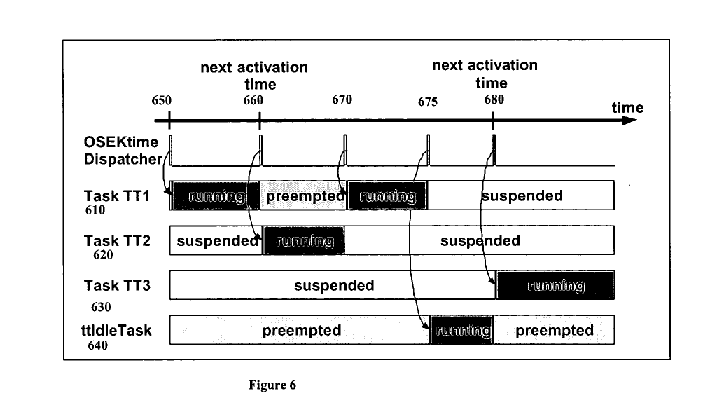

FIG. 6 shows an exemplary use of the states of FIG. 5 as applied to the present invention. Shown is the time triggered scheduling for first, second, third tasks and an idle task 610, 620, 630, 640. At a first time 650, the first task 610 is in the running state 500 and the second task 620 is in the suspended state 520. A third task 630 is also in the suspended state 520, and the idle task 640 is in the preempted state 510. The first time 650 could, for example, occur after the first task 610 has been scheduled and the idle task 640 has been preempted. At a first activation time 660 (e.g., the timer expires for a start time of the second task), the second task 620 enters the running state 500 and the first task 610 is moved to the preempted state 510. At a first stop time 670 (e.g., the second task finishes execution), the second task finishes executing and returns to the suspended state 520, and the first task 610 resumes the running state 500. At a second stop time 675 (e.g., the timer expires for the deadline time of the first task), the first task is moved to the suspended state 520, and the idle task 640 enters the running state 500. At a second activation time 680 (e.g., the timer expires for a start time of the third task), the third task 630 enters the running state 500, and the idle task 610 switches to the preempted state 510. In certain embodiments according to the present invention, if a task does not finish by the deadline, the operating system signals the relevant application via a procedure call and the system is reset.

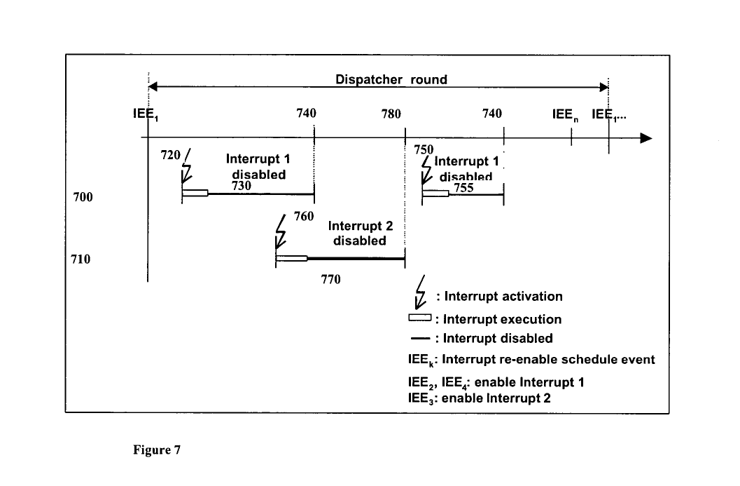

In certain embodiments of the present invention, ISRs can be handled as shown in FIG. 7. First and second interrupts 700, 710 are shown. Interrupts are disabled after the interrupts have been activated until a set time has elapsed. This is done by setting the timer for an interrupt re-enable event. When the timer expires, the interrupt is re-enabled. In FIG. 7, the first interrupt is activated at a first time 720 and then disabled 730 until a first interrupt re-enable schedule event 740. After the first interrupt re-enable schedule event 740 occurs, the first interrupt is activated again at a second time 750, and then disabled 755 again until the interrupt re-enable schedule event 740 re-occurs. While the first interrupt 700 is disabled, the second interrupt 710 is activated at a third time 760. After the second interrupt finishes execution, the second interrupt is disabled 770 until a second interrupt re-enable schedule event 780 occurs. The interrupt re-enable schedule events 740, 780 occur at a particular times specified by the table.

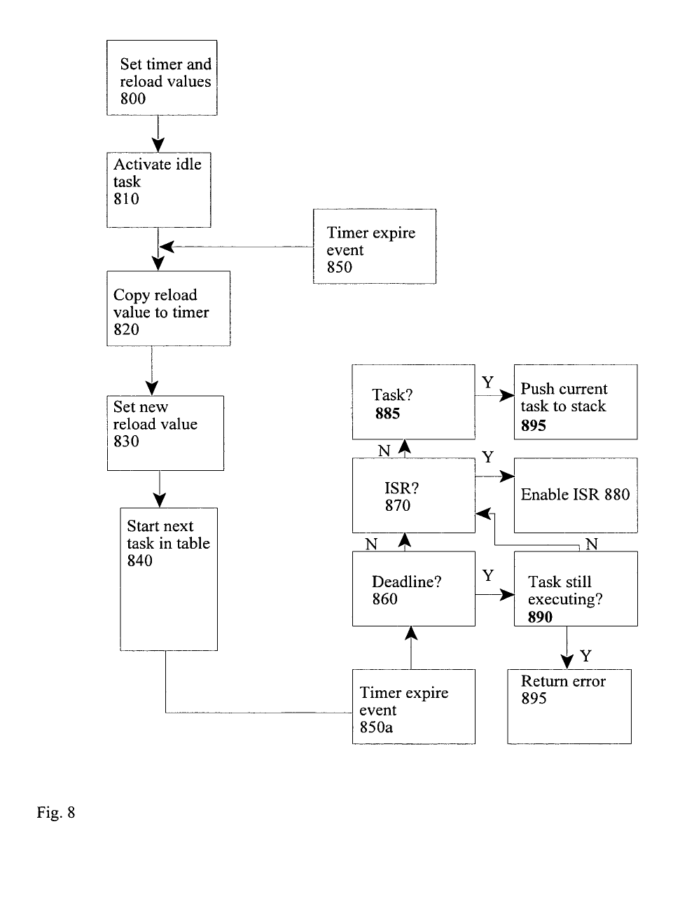

FIG. 8 shows a flow chart illustrating an exemplary method by which a time based operating system, according to the present invention, functions.

At power up, a timer and a reload value are set (Step 800). The timer would be set to expire at, e.g., a start time for a first task, stored in the table. The reload value would equal the amount of time increments that the timer must advance to reach the next event, i.e. time value stored in the table. This may be the start time for a second task, or the deadline for the first task, whichever is sooner. An idle task is then activated (Step 810). When the timer expires at the start time for the first task (Step 850), the timer ISR would cause the first task in the time table to begin execution (Step 840). The reload value determined in step 800 is copied into the timer (Step 820), and a new value is set for the reload value (Step 830). The new reload value would again be the amount of time increments the timer would have to advance to reach the next time value stored in the table.

When the timer expires again (Step 850a), the timer ISR scheduler checks, in the following order, whether the timer is for a task deadline (Step 860), for an ISR enable (Step 870), or for the start of a new task (Step 880).

If the timer is for a deadline (Step 860), the timer ISR runs a check to see if the task is still executing (Step 890). If the task is still executing, an error message is returned (Step 895). In certain embodiments according to the present invention, the message could be a fatal error that stops the processing of any other tasks or a command to restart the idler task. Otherwise, the method continues.

If the timer that has expired is for an ISR enable (Step 870), then the timer ISR causes the ISR to be enabled (Step 880). As discussed above, the timer would be set for an ISR enable time when a particular ISR is activated, according to an enable time set for the particular ISR, and stored in the table. The particular ISR would then be disabled until expiration of the enable time.

If the timer expires for start of a task (Step 885), then any currently executing task is preempted (e.g., pushed on the stack) (Step 895). Preferably, tasks and interrupts are pushed to separate stacks.

The method would copy the current reload value to the timer and then determine the next reload value.

While the tasks or ISRs are operating, an ISR, if activated, can interrupt a lower priority task or a lower priority interrupt. When such an ISR is activated, the currently executing task or interrupt (which has a lower priority than the interrupting ISR) is preempted until the ISR finishes executing. After the ISR has finished executing, the ISR is preempted from executing again until the expiration of an interrupt enable time set for the ISR and stored in the table, as described above.

Following is an example of operating system operation according to the flow chart of FIG. 8, using the values of FIG. 3B and Table 1. At power up, a timer ISR operates to set a timer at 1 ms, the start time of the first task 322 listed in the table. A reload value for the timer is set at 7 ms, and the idle task is activated. The 7 ms reload value equals the difference between the start time for the first task (1 ms) and the next time in the table, the 8 ms deadline for the first task. The idle task is a task used when no other tasks or interrupts are executing.

At 1 ms, the timer expires, and the reload value of 7 is copied into the timer. The reload value is then set to 2 (the next time value in the table (the 10 ms start time for the second task) minus the 8 ms deadline time for the first task). Task 1 is then activated.

At 8 ms (the 7 ms reload time that has elapsed since the 1 ms start time of the first task), the timer expires again. At this point in time, a check is made to see if the task is still executing. As noted above, if the first task is still executing, an error message is returned. If the first task is not executing, the 2 ms reload time is copied into the timer, such that the timer will expire again at 10 ms, the start time for the second task. The reload time is reset at 5 ms (the 15 ms start time for the third task minus the 10 ms start time of the second task).

The expiration of the timer and resetting of the reload time, followed by an appropriate action depending on the nature of the timer expiration, e.g., a task start time or deadline, continues through the entire table until, all of the tasks are executed.

In addition, the interrupt enable times are also tracked by the timer whenever an ISR is activated. For example, a particular ISR can be activated in response to a certain event. Upon activation, the timer ISR sets an enable time as a function of the enable information for the particular ISR stored in the table. The ISR, after execution, is disabled until expiration of the enable time set in the timer.

In certain embodiments according to the present invention, the time taken to execute the scheduler could be incorporated into the timer. The maximum time the scheduler will take to reschedule the tasks or interrupts is a known time. Also, for each reload value, deadline, task, or ISR, the time that the action will take is also known. Based upon the maximum time taken to reschedule and the time taken by the reload value, a maximum time for the scheduler to take its actions (e.g., swap tasks, etc) can be ascertained. The timer can then be modified to the timer value given in the table minus the time it takes for the scheduler to act. For example, at the 1 ms timer, the scheduler needs to schedule task 1 and reset the reload value. Assuming this takes a maximum of 15 ns, the 1 ms timer will actually expire at 985 ns.

Preferably, the table is stored in an embedded system in a read/write storage device (e.g., RAM). Most preferably, the table can be accessed and modified. Then, for example, during operation of the system, the results of the operation can be checked, and the various start times and deadlines can be changed to improve the functioning of the computing environment. In certain embodiments of the present invention, two or more tables could be used, for example, an executing table and a idle table. Data are written to the idle table, and then at the end of a cycle of start times stored in the executing table, a pointer could be moved to the currently idle table, thereby, making it the executing table.

In certain embodiments of the present invention, a plurality of timers, for example 3, could be used. For example, a timer mechanism comprising a separate timer for each of the task start times, the interrupts, and the deadlines is implemented.

The timer mechanism comprises a first timer set for a time out at each of a series of reload values, each reload value being equal to a number of time increments until a next start time in the time table, and a second timer set for a time out at each of a series of reload values, each reload value being equal to a number of time increments until a next deadline in the time table. The computer executes processes comprising, for example, time triggered tasks or ISR's associated with interrupts. When a process comprises an ISR, upon execution of the ISR, the ISR is disabled after execution, and enabled upon time out of a third timer at the expiration of the enable time. The third timer is set to time out at a reload value equal to the enable time. When each timer expires, a corresponding timer interrupt is generated. Moreover, the time table can comprise separate time tables, e.g. one time table for start times and anotehr time table for deadlines.

In certain embodiments of the present invention, different priority levels can be used. For example, the interrupt for the deadline timer is the highest, followed by the interrupt for the interrupt timer, followed by the interrupt for the task timer. The tasks and all other interrupts are at lower priorities than the timer interrupts. An exemplary priority schedule for this embodiment is shown in Table 2.

TABLE 2

Deadline timer interrupt: level 1
Interrupt timer interrupt: level 2
Task timer interrupt: level 3
ISR 1: level 4
.
.
.
task: level 5
ISR N: level 6
Idle: level 8

In certain embodiments according to the present invention, an entry (e.g., a flag) can be placed in the table to indicate whether a task can be interrupted during execution. The entry could override any interrupt enable times, or could pend any interrupts received.

In certain embodiments according to the present invention, after the scheduler has accessed the last element in the time table, the scheduler selects the first element in the time table as the next element. The scheduler then continues from that location in the table to select subsequent elements (e.g., the time table is repeated by the scheduler starting at the top of the time table after it reaches the end of the time table).

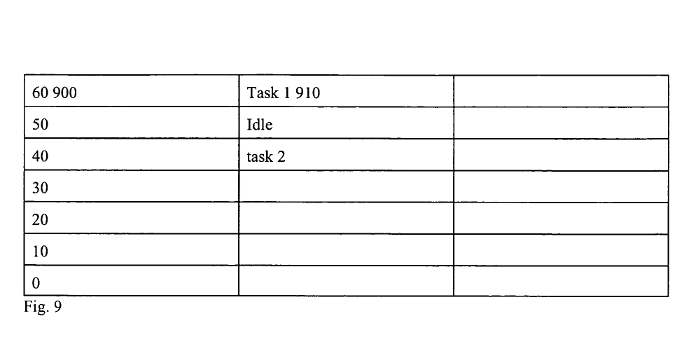

FIG. 9 illustrates an example of the present invention that utilizes a periodic timer. The periodic timer uses a total period, for example, of 60 ms. The periodic timer is then decreased by a granularity until it reaches 0 according to a granularity. The decreasing periodic timer is shown in a first column 900. The scheduler takes action at various time points during the countdown. The actions of the scheduler are shown in the second column 910.

Using the system detailed in FIG. 9, the scheduler is decremented as a function of the granularity (e.g., 10 ms in the example given in FIG. 9) to check for tasks and interrupts. This requires a portion of the time that could be spent processing a task or interrupt. So, if the granularity is reduced down to less than 1 ms, for example, more time would be spent executing the scheduler to check for tasks and interrupts than spent executing the tasks and interrupts. In contrast, using the reload value time out system of the present invention, the granularity is the time it takes to run the scheduler (e.g., the time between deadlines exceeds the minimum time to run the scheduler). As such, the embodiments according to the present invention can provide a finer granularity than the periodic timer solution.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. A method for scheduling execution of one or more processes in a computer, comprising the steps of:
providing a timer;
providing a series of events for each process of a preselected set of processes, the events comprising a start time for each process;
starting execution of each process based on a time out of the timer, each process starting execution according to the corresponding start time;
providing a table;
storing each event in the table; and
operating the timer to be set for a time out at each of a series of reload values, each reload value being equal to a number of time increments until a next event in the table.

2. The method according to claim 1 wherein the events further include a deadline for each process of the preselected set of processes;
based on a time out of the timer, stopping execution of an executing process regardless of whether the process has stopped execution normally, each process stopping execution according to the corresponding deadline.

3. The method of claim 1, wherein if one process starts execution while another process is executing, preempting the process already executing.

4. The method of claim 1 wherein each process comprises one of a task and an ISR.

5. The method of claim 4 wherein when a process comprises an ISR, upon execution of the ISR, providing an enable time.

6. The method of claim 5 comprising the further step of disabling the ISR after execution; and enabling the ISR upon expiration of the enable time.

7. A computer system comprising:
a timer;
a table storing a series of events for each process of a preselected set of processes, the events comprising a start time for each process;
an operating system causing execution of each process based on a time out of the timer, each process starting execution according to the corresponding start time stored in the table, the timer being arranged and configured to be set for a time out at each of a series of reload values, each reload value being equal to a number of time increments until a next event in the table.

8. The computer system of claim 7 wherein the table further stores events comprising a deadline for each process, the operating system causing, based on a time out of the timer, execution of an executing process to stop regardless of whether the process has stopped execution normally, each process stopping execution according to the corresponding deadline stored in the table.

9. The computer system of claim 8, wherein each process comprises one of a task and an ISR.

10. The computer system of claim 9 wherein when a process comprises an ISR, upon execution of the ISR, using an enable time in the table, the enable time causing disablement of an ISR after execution; and enablement of the ISR upon expiration of the enable time.

11. A method for scheduling one or more processes comprising the steps of:
providing a timer;
starting a plurality of processes based on a time out of the timer, each process starting execution according to a start time specified in a time table;
if one of the processes starts execution while another process is executing, preempting the process already executing;
if one of the processes has been preempted and the process that preempted the process stops execution, resuming the process that has been preempted; and
based on a time out of the timer, stopping execution of the processes regardless of whether the process has stopped execution normally, each process stopping execution according to a deadline specified in the time table;
setting the timer for a time out at each of a series of reload values, each reload value being equal to a number of time increments until a next one of a start time and deadline in the time table.

12. A method for scheduling one or more processes comprising the steps of:
providing a plurality of timers;
starting a plurality of processes based on a time out of a first one of the timers, each process starting execution according to a start time specified in a time table; and
based on a time out of a second one of the timers, stopping execution of the processes regardless of whether the process has stopped execution normally, each process stopping execution according to a deadline specified in the time table;
setting the first one of the timers for a time out at each of a series of reload values, each reload value being equal to a number of time increments until a next start time in the time table;
setting the second one of the timers for a time out at each of a series of reload values, each reload value being equal to a number of time increments until a next deadline in the time table.

13. The method according to claim 12 wherein each process comprises one of a task and an ISR, and comprising the further steps of when a process comprises an ISR, upon execution of the ISR, providing an enable time, disabling the ISR after execution; and enabling the ISR upon expiration of the enable time, the step of enabling being performed by setting a third one of the timers to time out after a reload value equal to the enable time.

14. A computer system comprising:
a timer mechanism;
a table storing a series of events for each process of a preselected set of processes, the events comprising a start time for each process and a deadline for each process;
an operating system causing execution of each process based on a time out of the timer mechanism, each process starting execution according to the corresponding start time stored in the table and stopping execution according to the corresponding deadline stored in the table, the timer mechanism being arranged and configured to be set for a time out at each of a series of reload values, each reload value being equal to a number of time increments until a next event in the table;
the timer mechanism comprising a first timer set for a time out at each of a series of reload values, each reload value being equal to a number of time increments until a next start time in the time table, and a second timer set for a time out at each of a series of reload values, each reload value being equal to a number of time increments until a next deadline in the time table.

15. The computer system of claim 14 wherein each process comprises one of a task and an ISR, and further comprising a third timer to time out after a reload value equal to an enable time wherein the enable time is set, when a process comprises an ISR, upon execution of the ISR, the ISR being disabled after execution; and enabled upon time out of the third timer at the expiration of the enable time.
